(19) United States
(12) Patent Application Publication
(10) Pub. No.: US 2015/0365982 A1
(43) Pub. Date: Dec. 17, 2015

(54) MASSIVE MIMO LINK SETUP

(71) Applicant: Sony Corporation, Tokyo (JP)

(72) Inventor: Erik Bengtsson, Eslov (SE)

(21) Appl. No.: 14/303,859

(22) Filed: Jun. 13, 2014

(51) Int. Cl. H04W 76/02; H04B 7/04

(52) U.S. Cl. CPC H04W 76/02; H04B 7/0413

(57) ABSTRACT

The invention is directed to establishing a massive multiple-input multiple-output (MIMO) link between an access point (AP) and a user equipment (UE). An exemplary method comprises: first repeatedly transmitting pilots from the UE to the AP for a first duration, wherein the first duration covers a portion of a data frame; listening at the UE for a response from the AP for substantially the first duration; in response to not receiving a response from the AP, second repeatedly transmitting pilots from the UE to the AP for a second duration, wherein the second duration covers at least a portion of the remaining portion of the data frame not covered during the first duration; and receiving an acknowledgment at the UE from the AP, and establishing the massive MIMO link between the UE and AP.

### BACKGROUND

Multiple-input and multiple-output (“MIMO”) is the use of multiple antennas at both a transmitter (e.g., an access point “AP” and/or user equipment “UE”) and a receiver (e.g., an AP and/or UE) in order to improve wireless communication between the transmitter and the receiver. Massive MIMO refers to using a large number of antennas (e.g., equal to or greater than a threshold number) at at least one of the transmitter and receiver. The large number of antennas may be arranged in an antenna array. Massive MIMO enables realization of high spectral efficiencies. One of the issues with massive MIMO is the setup or establishment of a link between the AP and the UE. The present invention is directed to an apparatus and method for addressing the issues encountered with the setup or establishment of the link between the AP and the UE.

### BRIEF SUMMARY

Embodiments of the invention are directed to a system, method, and computer program product for establishing a massive MIMO link between an AP and a UE. An exemplary method comprises first repeatedly transmitting pilots from the UE to the AP for a first duration, wherein the first duration covers a portion of a data frame; listening at the UE for a response from the AP for substantially the first duration; and in response to not receiving a response from the AP, second repeatedly transmitting pilots from the UE to the AP for a second duration, wherein the second duration covers at least a portion of the remaining portion of the data frame not covered during the first duration. In some embodiments, the data frame is a predefined data frame.

In some embodiments, the method further comprises receiving an acknowledgment at the UE from the AP, and establishing the massive MIMO link between the UE and AP.

In some embodiments, the method further comprises the second repeatedly transmitting step is executed after a delay that is equal to or greater than the second duration.

In some embodiments, the method further comprises listening for traffic from other UEs or from the AP.

In some embodiments, in response to picking up existing traffic during the listening step, the method comprises transmitting a synchronized pilot signal to the AP.

In some embodiments, the method further comprises synchronizing to a data frame pattern.

In some embodiments, the second duration at least partially covers the portion of the data frame.

In some embodiments, the method further comprises determining a location of the AP or the UE.

In some embodiments, the pilots comprise information associated with the AP.

In some embodiments, the AP is associated with an antenna array comprising a number of antennas equal to or greater than a threshold number of antennas.

In some embodiments, the method further comprises transmitting a pilot from the UE to the AP and determining whether a response is received at the UE from the AP.

In some embodiments, the method further comprises in response to determining a response is not received from the AP, executing the first repeatedly transmitting step.

In some embodiments, the method further comprises in response to determining a response is received from the AP, establishing the massive MIMO link between the UE and AP.

In some embodiments, a UE is provided for establishing a MIMO link between an AP and the UE. The UE comprises a memory; a processor; a module, stored in the memory, executable by the processor, and configured to first repeatedly transmit pilots from the UE to the AP for a first duration, wherein the first duration covers a portion of a data frame; listen at the UE for a response from the AP for substantially the first duration; and in response to not receiving a response from the AP, second repeatedly transmit pilots from the UE to the AP for a second duration, wherein the second duration covers at least a portion of the remaining portion of the data frame not covered during the first duration.

In some embodiments, a computer program product is provided for establishing a massive MIMO link between an AP and a UE. The computer program product comprises a non-transitory computer-readable medium comprising code configured to: first repeatedly transmit pilots from the UE to the AP for a first duration, wherein the first duration covers a portion of a data frame; listen at the UE for a response from the AP for substantially the first duration; and in response to not receiving a response from the AP, second repeatedly transmit pilots from the UE to the AP for a second duration, wherein the second duration covers at least a portion of the remaining portion of the data frame not covered during the first duration.

In some embodiments, another method is provided for establishing a massive multiple-input multiple-output (MIMO) link between an access point (AP) and a user equipment (UE). The method comprises transmitting, during a first timeslot, a first pilot from the UE to the AP; listening, during a second timeslot, for a response from the AP after transmitting the first pilot from the UE to the AP and before transmitting a second pilot from the UE to the AP, wherein a response period associated with a response from the AP is predetermined; and transmitting, during a third timeslot, a second pilot from the UE to the AP. Apparatus and computer program products may also be provided based on this method.

In some embodiments, the method further comprises transmitting a pilot from the UE to the AP and determining whether the response is received at the UE from the AP, and in response to determining the response is not received from the AP, transmitting the first pilot from the UE to the AP.

In some embodiments, the response is a response to the transmitted pilot, and not a response to the first pilot.

In some embodiments, a rate associated with pilot transmission from the UE to the AP is lower than a timeslot rate associated with a data header frame associated with data transmission from the UE to the AP.

In some embodiments, the method further comprises in response to determining the response is not received from the AP after a certain number of first timeslots, using at least one of the first timeslot or the third timeslot for listening for the response.

### BRIEF DESCRIPTION OF THE DRAWINGS

Having thus described embodiments of the invention in general terms, reference will now be made to the accompanying drawings, where:

FIG. 1 presents an exemplary block diagram for establishing a massive MIMO link, in accordance with embodiments of the present invention;

FIG. 2 presents an exemplary process flow establishing a massive MIMO link, in accordance with embodiments of the present invention;

FIG. 3 presents an exemplary network environment for establishing a massive MIMO link, in accordance with embodiments of the present invention;

FIG. 4 presents another exemplary block diagram for establishing a massive MIMO link, in accordance with embodiments of the present invention; and

FIG. 5 presents another exemplary process flow establishing a massive MIMO link, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

A network may be based on one or more network topologies. In an infrastructure topology, a network comprises a central device (an access point or “AP”) and one or more connected devices (user equipment or “UE”) that communicate with the AP and communicate with other connected devices via the AP. The AP may also be referred to as a base station. In other embodiments, the network may be based on other network topologies, such as a peer-to-peer (“P2P”) topology or a mesh network topology. This invention is not limited to any particular network topologies.

The present invention is directed to setting up a massive MIMO link without any synchronization information being exchanged between the transmitter and receiver. Essentially, in the present invention, in order to establish synchronized communication between a transmitter (e.g., a UE) and a receiver (e.g., an AP), the transmitter listens for uplink (“UL”) traffic to the receiver, and then transmits specific frames to the receiver. As used herein, traffic refers to data traffic on a communication channel or data channel. As used herein, a data frame or frame is a data transmission unit. The data frame may or may not include a frame synchronization sequence, i.e., a sequence of bits that indicates to the receiver the beginning and/or end of the data frame. As used herein, a data frame may be referred to as a data packet, data signal, data stream, data traffic, frame pattern, frame, data, traffic, or signal. In some embodiments, time division duplexing (“TDD”) is used to separate the UL and downlink (“DL”) data frames. Therefore, a data frame as described herein may be a TDD data frame.

In a network system as described herein, channel state information (“CSI”) refers to channel properties (e.g., scattering, fading, power decaying, etc.) of a communication channel. If the transmitter wants to estimate the CSI of a communication channel, the transmitter transmits a data frame comprising a pilot training sequence into the channel. A data frame comprising a pilot training sequence may simply be referred to as a pilot data frame, pilot frame, or just pilot.

One of the issues with massive MIMO is the setup of a link between the AP and the UE. An issue is that the AP is not able to utilize the antenna gain offered by the antenna array of the AP unless information (e.g., CSI) of the transmission channel between the UE and the AP is determined based on a pilot training sequence (or just pilot). It is important that this pilot is transmitted substantially synchronously with a data frame from the UE to the AP. Hence, in order to not contaminate or to be contaminated by a data signal from other UEs, the pilot needs to be transmitted from the UE when the AP is listening. The UE will not be able to communicate with the AP, and the AP will not be able to communicate with the UE, without this pilot being transmitted from the UE to the AP. A proposed method to solve this issue is to hand over data comprising the necessary synchronization information from a macro cell to the UE. A macro cell is a high power (e.g., equal to or greater than a threshold power) AP that has a large coverage area (e.g., equal to or greater than a threshold coverage area). In some embodiments, the proposed invention may be enabled with a Wireless Fidelity (“WiFi”) AP.

The method described herein is directed to setting up a massive MIMO link and comprises two steps. In the first step, the UE listens for traffic from other UEs and synchronize to a frame pattern. Then, a predetermined pilot slot is used for pilot transmission from the UE to a specific or intended AP. If the UE receives a response from the intended AP, a link is set up between the UE and the AP. If not, the invention moves to the second step.

In the second step, the UE repeatedly transmits pilots (intended for an AP) for a duration substantially equal to the length of the header and UL part of the frame. Then, the UE listens for a response from the AP for substantially the same period of time. If there is no answer from the AP, the procedure is repeated by the UE with a delay that is large enough to at least cover the part of a frame that was not covered during the first attempt with continuous pilot transmissions. Alternate embodiments of the method are described later in the specification.

The method described herein can be triggered based on the location of the UE and/or the AP. For example, the method is triggered if the UE enters a certain area or if the UE's distance is less than a threshold distance from an AP. In alternate embodiments, the location of the UE can be determined based on geographical positioning system (GPS) coordinates associated with the UE. In other embodiments, the user of the UE can initiate the method described herein. In still other embodiments, the UE periodically attempts to establish communication with the AP using the method described herein. The present invention is useful because it does not degrade the performance of neighboring cells (or neighboring APs). As used herein, a cell may also be referred to as an AP, or as comprising an AP. If a UE described herein attempts to synchronize with a neighboring cell, the second step described previously is triggered.

The pilots transmitted from the UE to the AP for link setup request (LSUR) purposes need to include unique information in order to be different from pilots in an already ongoing data session. The setup pilots can also include information about the target APs in order to not confuse other APs that can detect or receive the pilots. If the LSUR pilot has no specific target AP, an AP that detects or receives the pilot will respond to the UE with identification (ID) information for the AP in the acknowledgment transmitted from the AP to the UE.

The method described herein works for a network system or environment with a predefined frame structure (e.g., frame length, UL/DL ratio, etc.). Additionally, the method described herein can work for any frame length or any UL/DL ratio. The method described herein works based on defining an expected response time (from the AP) from the moment a pilot is transmitted from the UE to the AP. In the event that the frame length can be dynamically changed, the UE will need to attempt different delay lengths between LSUR frames. In such an event, more than two LSUR frames may be necessary. In some embodiments, the UE attempts different delay lengths between frames that are of different network standards or operation modes.

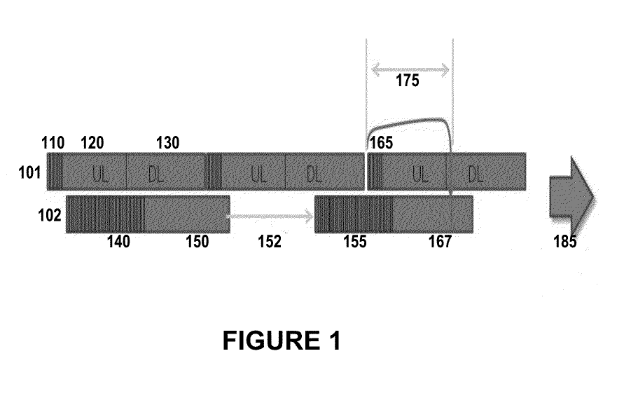

Referring now to FIG. 1, FIG. 1 illustrates an exemplary block diagram for setting up a massive MIMO link. Once the massive MIMO link is established, synchronized communication 185 is enabled between the UE and the AP. As used herein, communication refers to transmitting data from the UE to the AP and/or receiving data at the UE from the AP. FIG. 1 presents an AP frame pattern 101 and a UE frame pattern 102. The AP frame pattern 101 comprises a header 110 (also referred to as pilot header 110), an uplink pattern 120, and a downlink pattern 130. In some embodiments, the header 110, the uplink pattern 120, and the downlink pattern 130 are contiguous. In other embodiments, the header 110, the uplink pattern 120, and the downlink pattern 130 are not contiguous. The UE frame pattern 102 comprises a frame pattern for continuous pilots 140 and a frame pattern 150 during which the UE listens for acknowledgment from the AP. In some embodiments, the continuous pilots 140 and the frame pattern 150 are contiguous, while in other embodiments, the continuous pilots 140 and the frame pattern 150 are not contiguous.

As indicated in FIG. 1, the UE transmits the continuous pilots 140 after the pilot header 110. Additionally, there is a delay 152 after the frame pattern 150. The length of the delay 152 is substantially equal to one-half of a UE frame pattern 102. The UE frame pattern 102 comprises the continuous pilots 140 and the frame pattern 150. The delay 152 is essentially a delay between two LSUR pilots as described below. This delay length is sufficient for a scenario where the uplink frame pattern 120 is substantially equal to the downlink frame pattern 130. As indicated in FIG. 1, two (2) LSUR pilots are sufficient to establish a massive MIMO link between the UE and the AP. Both the continuous pilots 140 and the continuous pilots 155 are LSUR pilots. Since none of the continuous pilots 140 hit the pilot window (e.g., the pilot header 110) in the AP frame pattern 101, no acknowledgment (“acc” or “ack”) is received at the UE from the AP. On the contrary, at least one of the continuous pilots 155 hits the pilot window (e.g., the pilot header 165) in the AP frame pattern 101. When this happens, an acknowledgment 167 is transmitted from the AP to the UE. The response time 175 for receiving the acknowledgment at the UE is indicated in FIG. 1.

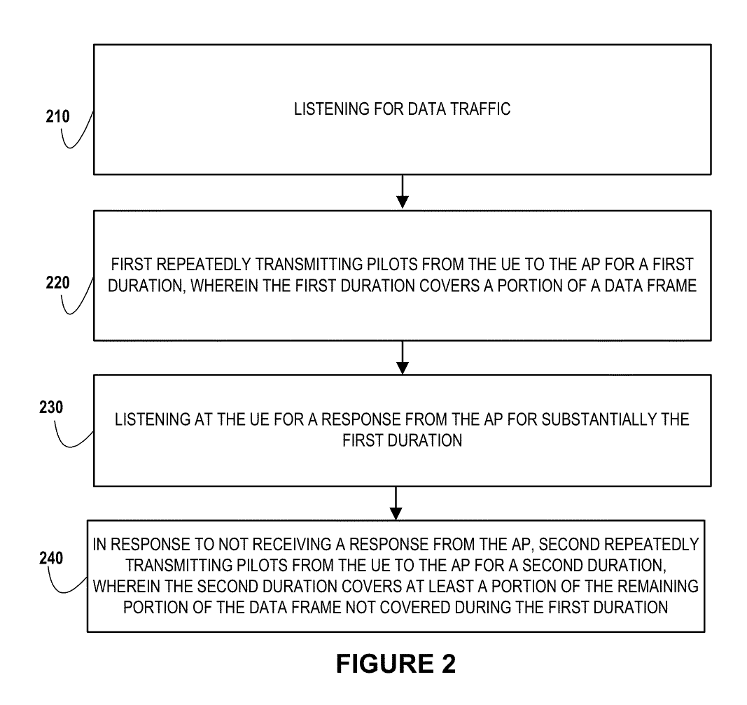

Referring now to FIG. 2, FIG. 2 illustrates an exemplary process flow for establishing a massive MIMO link between an AP and a UE, in accordance with embodiments of the invention. The AP may be associated with an antenna array comprising a number of antennas equal to or greater than a threshold number of antennas. At block 210, the process flow comprises listening at the UE for data traffic. The data traffic may be traffic associated with other UEs or the AP. In some embodiments, when the UE is listening for traffic, the UE may pick up signals (e.g., from other UEs or the AP) and may then be able to send pilot signals to an intended AP, which are already synchronized with the existing traffic. In such embodiments, the setup duration for the MIMO link will be short (e.g., less than a threshold duration).

At step 220, the process flow comprises first repeatedly transmitting pilots from the UE to the AP for a first duration, wherein the first duration covers a portion of a data frame (e.g., a predefined data frame). The pilots may comprise information about the intended AP. Prior to executing step 220, the process flow comprises listening, at the UE, for traffic from other UEs, and synchronizing to a data frame pattern. At step 230, the process flow comprises listening at the UE for a response from the AP for substantially the first duration. At step 240, the process flow comprises in response to not receiving a response from the AP (e.g., during the first duration), second repeatedly transmitting pilots from the UE to the AP for a second duration, wherein the second duration covers at least a portion of the remaining portion of the data frame not covered during the first duration. The second repeatedly transmitting step is executed after a delay that is equal to or greater than the second duration (or the first duration in some embodiments). In some embodiments, the second duration at least partially covers the portion of the data frame. The process flow further comprises receiving an acknowledgment at the UE from the AP, and establishing the massive MIMO link between the UE and AP. In some embodiments, the process flow further comprises determining a location of the AP or the UE. Therefore, the present invention enables a MIMO link between the UE and the AP without exchange of synchronization information between the UE and the AP.

Prior to executing block 220, the process flow may comprise transmitting a pilot from the UE to the AP and determining whether a response is received at the UE from the AP. In response to determining a response is not received from the AP, the process flow comprises executing the first repeatedly transmitting step. In response to determining a response is received from the AP, the process flow comprises establishing the massive MIMO link between the UE and AP.

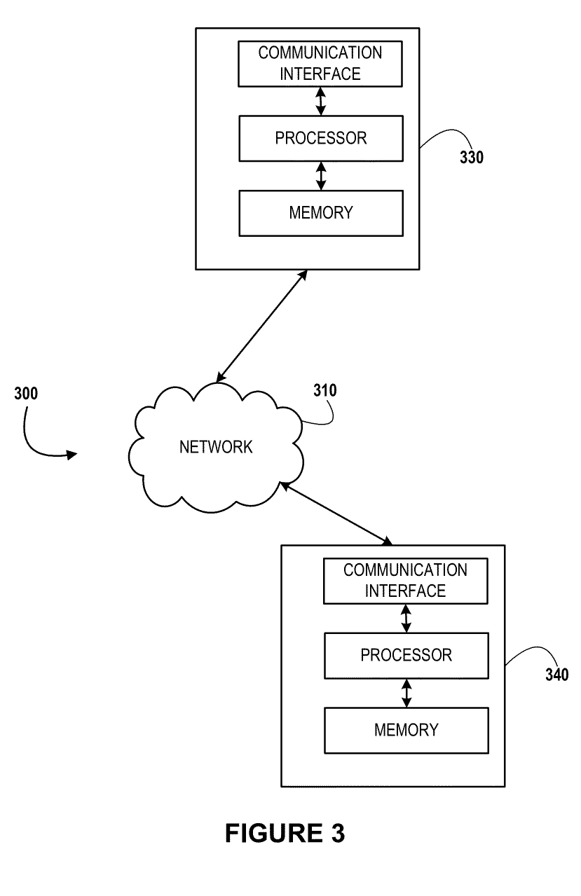

Referring now to FIG. 3, FIG. 3 presents an exemplary block diagram of the network environment for establishing a massive MIMO link, in accordance with embodiments of the present invention. As illustrated, the network environment includes a network 310, an AP 330, and a UE 340. As shown in FIG. 3, the AP 330 and the UE 340 are each operatively and selectively connected (e.g., via one or more wired or wireless mechanisms) to the network 310, which may include one or more separate networks.

Each of the AP 330 and the UE 340 is a computing device that comprises a communication interface, a processor, a memory, and a module stored in the memory, executable by the processor, and configured to perform the various processes described herein. Each communication interface described herein enables communication with other systems via the network 310.

Each processor described herein generally includes circuitry for implementing audio, visual, and/or logic functions. For example, the processor may include a digital signal processor device, a microprocessor device, and various analog-to-digital converters, digital-to-analog converters, and other support circuits. Control and signal processing functions of the system (e.g., first device or second device) in which the processor resides may be allocated between these devices according to their respective capabilities. The processor may also include functionality to operate one or more software programs based at least partially on computer-executable program code portions thereof, which may be stored, for example, in a memory.

Each memory may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

In alternate embodiments, a method is provided to set up a massive MIMO link. In this method, a response delay is predefined or predetermined. This enables an unsynchronized UE to be able to transmit pilots to an AP at a rate low enough to enable acknowledgment from the AP to fit between successive pilot transmissions. This method comprises two steps. In the first step, the UE listens for traffic from other UEs and synchronize to a frame pattern. Then, a predetermined pilot slot might be used for pilot transmission from the UE to a specific or intended AP. Alternatively, a burst of pilots may be transmitted if pilot slot hopping is in use or if no dedicated pilot slot is available for setting up a massive MIMO link. If the UE receives a response from the intended AP, a link is set up between the UE and the AP. If not, the invention moves to the second step.

In the second step, the UE transmits (e.g., to the AP) pilots repeatedly at a data rate lower than a timeslot rate in a standard data frame header. In the time slots between transmitting the pilots, the UE listens for the AP to respond to the UE's transmissions. The delay from the UE's transmission to the AP's response may be predetermined. The UE might initially transmit a pilot in every timeslot and then change to every other timeslot or fewer timeslots (i.e., fewer than every other timeslot) after a time equal to the response delay in order to listen for acknowledgment from the AP. As used herein, a pilot may also be referred to as a training sequence.

After a maximum frame length or a duration associated with the maximum frame length, the UE may stop transmitting pilots and just listen for acknowledgment from the AP for a period that is at least equal to the response delay. Compared to the other embodiment described herein, this alternative embodiment enables faster link setup as the pilot hits the next available header. Additionally, this alternative embodiment has less impact on the system described herein as it may contaminate only a single frame. Additionally, this alternative embodiment is more flexible to frame structure. However, as described previously, this alternative embodiment requires a defined response delay.

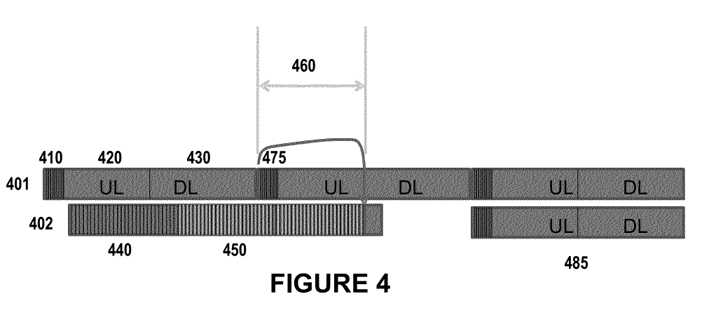

Referring now to FIG. 4, FIG. 4 illustrates an exemplary block diagram for setting up a massive MIMO link. Once the massive MIMO link is established, synchronized communication 485 is enabled between the UE and the AP. As used herein, communication refers to transmitting data from the UE to the AP and/or receiving data at the UE from the AP. Synchronized communication refers to an instance when the header, uplink pattern, and downlink pattern comprised in the AP frame pattern 401 is substantially synchronous with or overlaps the header, uplink pattern, and downlink pattern comprised in the UE frame pattern 402. FIG. 4 presents an AP frame pattern 401 and a UE frame pattern 402. The AP frame pattern 401 comprises a header 410 (also referred to as pilot header 410), an uplink pattern 420, and a downlink pattern 430. In some embodiments, the header 410, the uplink pattern 420, and the downlink pattern 430 are contiguous. In other embodiments, the header 410, the uplink pattern 420, and the downlink pattern 430 are not contiguous. The UE frame pattern 402 comprises a frame pattern 440 comprising pilot slots or pilots followed by another frame pattern 450 that alternates between pilot slots or pilots and acknowledgment slots. The frame patterns 440 and 450 are link setup patterns. The length of the response delay 460 is predetermined. After the response delay 460, the UE may retransmit pilots or may continue to wait for a response from the AP if a response has not been received from the AP. However, if a pilot hits the pilot header 475 and a response is received from the AP after a time period substantially equal to the response delay, synchronized communication may be established between the UE and AP. Once synchronized communication is established between the UE and the AP, the UE and the AP have substantially similar or same frame patterns.

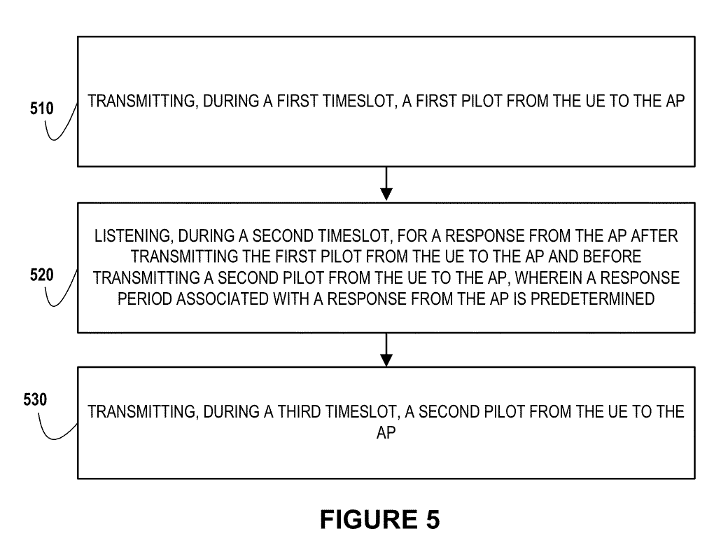

Referring now to FIG. 5, FIG. 5 illustrates another exemplary process flow for establishing a massive MIMO link between an AP and a UE, in accordance with embodiments of the invention. At block 510, the process flow comprises transmitting, during a first timeslot, a first pilot from the UE to the AP. At step 520, the process flow comprises listening, during a second timeslot, for a response from the AP after transmitting the first pilot from the UE to the AP and before transmitting a second pilot from the UE to the AP, wherein a response period associated with a response from the AP is predetermined. The response from the AP is not a response to the first pilot, but rather a response to an earlier pilot transmitted from the UE to the AP. The delay from the UE's transmission of this earlier pilot to the AP's response may be predetermined. At step 530, the process flow comprises transmitting, during a third timeslot, a second pilot from the UE to the AP. In response to determining a response is not received from the AP after a certain number of first timeslots, the process flow further comprises using at least one of the first timeslot or the third timeslot for listening for the response. In some embodiments, a rate associated with pilot transmission from the UE to the AP is lower than a timeslot rate associated with a data header frame associated with data transmission from the UE to the AP.

The invention is not limited to any particular types of systems or devices that can take the form of the AP and/or the UE. As used herein, a device may also be referred to as a system or apparatus. Examples of devices include mobile phones or other mobile computing devices, mobile televisions, laptop computers, smart screens, tablet computers or tablets, portable desktop computers, e-readers, scanners, portable media devices, gaming devices, cameras or other image-capturing devices, headgear, eyewear, watches, bands (e.g., wristbands) or other wearable devices, servers, routers, sensors, Internet of Things (IOTs), non-computing devices or systems, etc.

In accordance with embodiments of the invention, the term “module” with respect to a system (or a device) may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method for establishing a massive multiple-input multiple-output (MIMO) link between an access point (AP) and a user equipment (UE), the method comprising:
first repeatedly transmitting pilots from the UE to the AP for a first duration, wherein the first duration covers a portion of a data frame;
listening at the UE for a response from the AP for substantially the first duration; and
in response to not receiving a response from the AP, second repeatedly transmitting pilots from the UE to the AP for a second duration, wherein the second duration covers at least a portion of the remaining portion of the data frame not covered during the first duration.

2. The method of claim 1, further comprising receiving an acknowledgment at the UE from the AP, and establishing the massive MIMO link between the UE and AP.

3. The method of claim 1, wherein the second repeatedly transmitting step is executed after a delay that is equal to or greater than the second duration.

4. The method of claim 1, further comprising listening for traffic from other UEs or from the AP.

5. The method of claim 4, further comprising in response to picking up existing traffic during the listening step, transmitting a synchronized pilot signal to the AP.

6. The method of claim 1, further comprising synchronizing to a data frame pattern.

7. The method of claim 1, wherein the second duration at least partially covers the portion of the data frame.

8. The method of claim 1, further comprising determining a location of the AP or the UE.

9. The method of claim 1, wherein the pilots comprise information associated with the AP.

10. The method of claim 1, wherein the AP is associated with an antenna array comprising a number of antennas equal to or greater than a threshold number of antennas.

11. The method of claim 1, wherein the data frame comprises a predefined data frame.

12. The method of claim 1, further comprising transmitting a pilot from the UE to the AP and determining whether a response is received at the UE from the AP.

13. The method of claim 12, further comprising in response to determining a response is not received from the AP, executing the first repeatedly transmitting step.

14. The method of claim 12, further comprising in response to determining a response is received from the AP, establishing the massive MIMO link between the UE and AP.

15. A user equipment (UE) for establishing a massive multiple-input multiple-output (MIMO) link between an access point (AP) and the UE, the UE comprising:
a memory;
a processor;
a module, stored in the memory, executable by the processor, and
configured to:
first repeatedly transmit pilots from the UE to the AP for a first duration, wherein the first duration covers a portion of a data frame;
listen at the UE for a response from the AP for substantially the first duration; and
in response to not receiving a response from the AP, second repeatedly transmit pilots from the UE to the AP for a second duration, wherein the second duration covers at least a portion of the remaining portion of the data frame not covered during the first duration.

16. A method for establishing a massive multiple-input multiple-output (MIMO) link between an access point (AP) and a user equipment (UE), the method comprising:
transmitting, during a first timeslot, a first pilot from the UE to the AP;
listening, during a second timeslot, for a response from the AP after transmitting the first pilot from the UE to the AP and before transmitting a second pilot from the UE to the AP, wherein a response period associated with a response from the AP is predetermined; and
transmitting, during a third timeslot, a second pilot from the UE to the AP.

17. The method of claim 16, further comprising transmitting a pilot from the UE to the AP and determining whether the response is received at the UE from the AP, and in response to determining the response is not received from the AP, transmitting the first pilot from the UE to the AP.

18. The method of claim 17, wherein the response is a response to the transmitted pilot, and not a response to the first pilot.

19. The method of claim 16, wherein a rate associated with pilot transmission from the UE to the AP is lower than a timeslot rate associated with a data header frame associated with data transmission from the UE to the AP.

20. The method of claim 16, further comprising in response to determining the response is not received from the AP after a certain number of first timeslots, using at least one of the first timeslot or the third timeslot for listening for the response.
